(19) United States
(12) Patent Application Publication
(10) Pub. No.: US 2017/0036493 A1
(43) Pub. Date: Feb. 9, 2017

(54) RUN-FLAT TIRE

(71) Applicant: BRIDGESTONE CORPORATION, Chuo-ku, Tokyo (JP)

(72) Inventor: Gaku OGAWA, Chuo-ku, Tokyo (JP)

(73) Assignee: Bridgestone Corporation, Chuo-ku, Tokyo (JP)

(21) Appl. No.: 15/303,737

(22) PCT Filed: Feb. 6, 2015
(86) PCT No.: PCT/JP2015/053396

§ 371 Date: Oct. 13, 2016

(30) Foreign Application Priority Data
Apr. 14, 2014 (JP) 2014-083086

(51) Int. Cl. B60C 17/00; B60C 19/00; B60C 11/03

(52) U.S. Cl. CPC B60C 17/0009; B60C 11/0304; B60C 19/001; B60C 2011/0353

(57) ABSTRACT

A run-flat tire has a carcass that spans a region between a pair of bead portions, a side reinforcement layer that is provided at a tire side portion that connects the bead portions and a tread portion, an inclined belt layer that is provided at an outer side of the carcass in a tire radial direction so as to span a tire equatorial plane CL, and that is formed by cords that are inclined relative to the tire circumferential direction, and a reinforcement cord layer that is provided at an outer side of the inclined belt layer in the tire radial direction, and only on a half portion of the tire that is located on an inner side in a tire fitting direction of the tire equatorial plane CL, and that is formed by cords that are inclined relative to the tire circumferential direction.

### TECHNICAL FIELD

The present invention relates to a run-flat tire.

### BACKGROUND ART

A side-reinforced run-flat tire in which a tire side portion is reinforced by side reinforcement rubber is disclosed in JPA 2012-116212 as a run-flat tire that is able to travel for a prescribed distance even when the tire has punctured and has reduced internal pressure.

### SUMMARY OF THE INVENTION

### Technical Subject

In a side-reinforced run-flat tire, when the tire is traveling under reduced internal pressure (i.e., during run-flat traveling), if the vehicle makes a turn or the like resulting in a slip angle being input, a buckling phenomenon occurs in which the tire side portions bend towards an inner side of the tire. However, from the standpoints of the acceleration performance and fuel consumption of the vehicle, it is preferable that a weight of the vehicle not be increased. For this reason, a run-flat tire that makes it possible to prevent a buckling phenomenon from occurring while also restricting any increase in a weight of the tire is desired.

The present invention was conceived in view of the above-described circumstances and it is an object thereof to provide a run-flat tire that makes it possible to suppress the occurrence of a buckling phenomenon in a tire side portion during run-flat traveling, at the same time as any increase in the tire weight is also suppressed.

### Solution to the Subject

A run-flat tire according to a first aspect of the present invention has a carcass that spans a region between a pair of bead portions, a side reinforcement layer that is provided at a tire side portion that connects the bead portions and a tread portion, an inclined belt layer that is provided at an outer side of the carcass in a tire radial direction so as to span a tire equatorial plane, and that is formed by cords that are inclined relative to a tire circumferential direction, and a reinforcement cord layer that is provided at an outer side of the inclined belt layer in the tire radial direction, and only at a half portion of the tire that is located at an inner side in a tire fitting direction of the tire equatorial plane, and that is formed by cords that are inclined relative to the tire circumferential direction.

### Advantageous Effects of the Invention

Because the present invention has the above-described structure, it is possible to suppress the occurrence of a buckling phenomenon in a tire side portion during run-flat traveling, at the same time as any increase in the tire weight is also suppressed.

### BRIEF DESCRIPTION OF THE DRAWINGS

FIG. 1 is a cross-sectional view showing a cross-section taken in a tire axial direction of a run-flat tire according to a first embodiment.

FIG. 2 is a cross-sectional view showing a cross-section taken in the tire axial direction, and showing a state in which the run-flat tire according to the first embodiment is traveling in a run-flat state.

FIG. 3 is a cross-sectional view showing a cross-section taken in a tire axial direction of a run-flat tire according to a second embodiment.

FIG. 4 is a side view as seen from a tire axial direction showing a run-flat tire of a comparative example during run-flat traveling.

FIG. 5 is a graph showing a relationship between a rim separation index for an inner side in a tire fitting direction and a rim separation index for an outer side in the tire fitting direction

### DESCRIPTION OF THE EMBODIMENTS

### First Embodiment

(Structure of a Run-Flat Tire)

Hereinafter, a run-flat tire 10 (hereinafter, this will be referred to as a tire 10) according to a first embodiment of the present invention will be described with reference made to the drawings. Note that an arrow TW in the drawings shows a width direction of the tire 10 (i.e., a tire width direction), while an arrow TR shows a radial direction of the tire 10 (i.e., a tire radial direction). In addition, IN in the drawings shows an inner side in the tire fitting direction, while OUT in the drawings shows an outer side in the tire fitting direction. The tire width direction referred to here is a direction that is parallel to an axis of rotation of the tire 10, and is also sometimes referred to as the tire axial direction. Moreover, the tire radial direction refers to a direction that is orthogonal to the axis of rotation of the tire 10. The symbol CL denotes an equatorial plane of the tire 10 (i.e., a tire equatorial plane). Furthermore, in the present embodiment, the axis of rotation side of the tire 10 in the tire radial direction is referred to as the ‘tire radial direction inner side’, while the opposite side from the axis of rotation side of the tire 10 in the tire radial direction is referred to as the ‘tire radial direction outer side’. In addition, the equatorial plane CL side of the tire 10 in the tire width direction is referred to as the ‘tire width direction inner side’, while an opposite side from the equatorial plane CL of the tire 10 in the tire width direction is referred to as a ‘tire width direction outer side’.

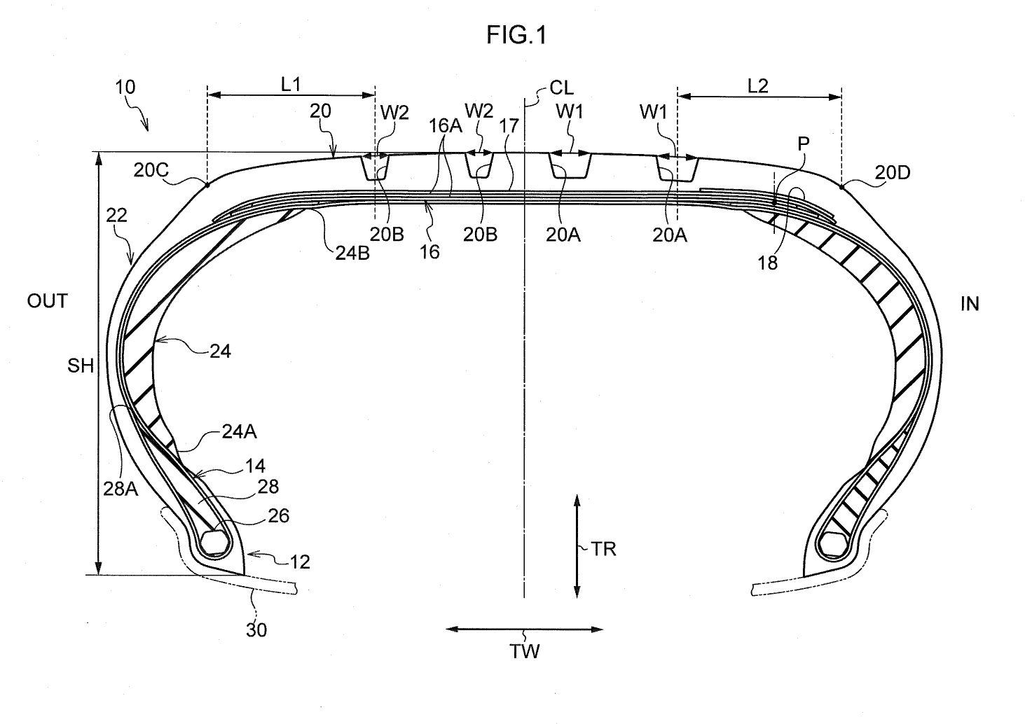

A tire 10 that has been fitted onto a standard rim 30 and inflated to a standard air pressure is shown in FIG. 1. Here, the right side in the drawings is the tire fitting direction inner side. Moreover, the standard rim referred to here is a rim prescribed in the JATMA (Japan Automobile Tire Manufacturers Association) Yearbook for 2013. Furthermore, the aforementioned standard air pressure is an air pressure that corresponds to the maximum load capacity given in the JATMA (Japan Automobile Tire Manufacturers Association) Yearbook for 2013.

Note that in the following description, the load refers to the maximum load (i.e., the maximum load capacity) for a wheel of an appropriate size which is disclosed in the following Standard, and the internal pressure refers to an air pressure that corresponds to the maximum load (i.e., the maximum load capacity) per wheel which is also disclosed in the following Standard. The rim refers to a standard rim (or an ‘Approved Rim’ or ‘Recommended Rim’) in an appropriate size which is disclosed in the following Standard. The Standard is determined by the industrial Standards that are valid in the region where the tire is produced or used. For example, in the United States of America, the Standard is prescribed by ‘The Tire and Rim Association Inc. Year Book’. In Europe, the Standard is prescribed by ‘The European Tire and Rim Technical Organization Standards Manual. In Japan, the Standard is prescribed by the Japan Automobile Tire Association JATMA Year Book.

As is shown in FIG. 1, the tire 10 according to the present embodiment has a tire size of 215/60R17. The tire 10 is provided principally with a pair of bead portions 12, a carcass 14, an inclined belt layer 16, a cap layer 17, a reinforcement cord layer 18, a tread portion 20, a tire side portion 22, and side reinforcement rubber 24 which serves as a side reinforcement layer. Here, the tire 10 is assembled onto a standard rim 30, and if the tire cross-sectional height SH is taken as a length of half the difference between the tire outer diameter and the rim diameter when the tire internal pressure is the standard air pressure, then the tire cross-sectional height SH of the tire 10 shown in FIG. 1 is set to 115 mm or more. In the present embodiment, as an example, the tire cross-sectional height SH is set to 129 mm. Note that the present invention is not limited to this, and a tire in which the cross-sectional height SH is less than 115 mm may also be used. It is also preferable that the oblateness is 55% or more.

The bead portions 12 are provided as a pair at a distance from each other on the left and right sides in the tire width direction. A bead core 26 is embedded in each one of the pair of bead portions 12. The carcass 14 spans the distance between the bead cores 26.

The carcass 14 is formed by either one or a plurality of carcass plies 14. The carcass plies are formed by covering a plurality of cords (for example, organic fiber cords or metal cords or the like) with a rubber covering. The carcass 14 which is formed in this manner extends in a toroidal shape from one bead core 26 to the other bead core 26, so as to form the skeleton of the tire. In addition, both one end portion and another end portion of the carcass 14 are folded around the bead cores 26 from the tire inner side towards the tire outer side, and extend as far as the tread portion 20 (described below). Note that, in the present embodiment, the one end portion and the other end portion of the carcass 14 are folded around the bead cores 26 and are anchored in position, however the present invention is not limited to this. For example, it is also possible to employ a structure in which a plurality of bead core pieces are arranged in the bead portions 12, and the carcass 14 is sandwiched between the plural bead core pieces. Furthermore, it is also possible for the one end portion and the other end portion of the folded carcass 14 to terminate at the tire side portions 22.

Bead fillers 28 that extend from the bead cores 26 outwards in the tire radial direction are embedded in areas of the bead portions 12 that are sandwiched by the carcass 14. End portions 28A that are located on an outer side in the tire radial direction of the bead fillers 28 penetrate into the tire side portions 22, and a thickness of the bead fillers 28 decreases moving towards the outer side in the tire radial direction. Note that there are no particular restrictions as to the shape and materials of the bead fillers 28.

The inclined belt layer 16 is placed on an outer side in the tire radial direction of the carcass 14. The inclined belt layer 16 is formed by either one or a plurality of belt plies 16A. In the present embodiment, as an example, the inclined belt layer 16 is formed by two belt plies 16A. The belt plies 16A are formed by covering a plurality of cords (for example, organic fiber cords or metal cords or the like) with a rubber covering. The cords that are used to form the belt plies 16A are placed at an inclination relative to the tire circumferential direction. In the present embodiment, as an example, the cords are placed at an angle of inclination of between 15° and 30°. The inclined belt layer 16 is formed extending from one end portion in the tire radial direction of the tread portion 20 to the other end portion thereof so as to span the tire equatorial plane CL.

The cap layer 17 is provided as a belt reinforcement layer on an outer side in the tire radial direction of the inclined belt layer 16. The cap layer 17 is formed by cords that extend in the tire circumferential direction, and is positioned such that it covers the entire inclined belt layer 16.

The reinforcement cord layer 18 is placed on an outer side in the tire radial direction of the cap layer 17. The reinforcement cord layer 18 is formed by diagonally positioning a plurality of cords (for example, organic fiber cords or metal cords or the like) at an angle of inclination of between 60° and 90° relative to the tire circumferential direction. In the present embodiment, as an example, the cords are diagonally positioned at an angle of inclination of 90°. Organic fiber cords and metal cords are used for the cords that form the reinforcement cord layer 18. In the present embodiment, as an example, PET is used.

The reinforcement cord layer 18 is placed on the inner side in the tire fitting direction of the tire equatorial plane CL. The reinforcement cord layer 18 is not placed on the outer side in the tire fitting direction of the tire equatorial plane CL. The reinforcement cord layer 18 is placed on a tire shoulder portion such that it overlaps in the tire radial direction with the inclined belt layer 16 and the cap layer 17. Note that in the present embodiment, the reinforcement cord layer 18 is placed on the tire shoulder portion, however, the present invention is not limited to this. For example, it is also possible for one end portion of the reinforcement cord layer 18 that is located on the inner side in the tire width direction to extend as far as the tire equatorial plane CL. It is also possible for a plurality of the reinforcement cord layers 18 to be placed in this position. In addition, if a position that is offset from one end portion on the outer side in the tire width direction of the inclined belt layer 16 towards the inner side in the tire width direction by 14% of the tire cross-sectional height SH is taken as a position P, then this position P is the position that bends the most when a buckling phenomenon occurs. Because of this, it is preferable for the one end portion on the inner side in the tire width direction of the reinforcement cord layer 18 to extend as far as the position P.

It is also preferable for the reinforcement cord layer 18 and the side reinforcement rubber 24 to be positioned such that they overlap each other in the tire width direction by a distance of 7.5% or more of the tire cross-sectional height SH. It is also preferable for the reinforcement cord layer 18 and the side reinforcement rubber 24 to be positioned such that they overlap each other in the tire width direction by a distance of 6% or more of the width of the reinforcement cord layer 18.

The tread portion 20 is placed on an outer side in the tire radial direction of the inclined belt layer 16 and the cap layer 17. The tread portion 20 is in contact with the road surface when the tire is being used on a road, and a plurality of circumferential direction grooves 20A and circumferential direction grooves 20B that extend in the tire circumferential direction are formed in the surface of the tread portion 20. Additionally, width direction grooves (not shown) that extend in the tire width direction are also formed in the tread portion 20. Note that the shape and number of the circumferential direction grooves 20A and width direction grooves are suitably set in accordance with the performance required from the tire 10 such as the water drainage and steering stability and the like.

Here, in the present embodiment, the total groove width of the circumferential direction grooves 20A that are provided at the inner side in the tire fitting direction (i.e., on the right side in the drawing) of the tire equatorial plane CL is greater than the total groove width of the circumferential direction grooves 20B that are provided at the outer side in the tire fitting direction (i.e., on the left side in the drawing) of the tire equatorial plane CL.

More specifically, two circumferential direction grooves 20A are provided at the inner side in the tire fitting direction of the tire equatorial plane CL. A groove width W1 of an aperture surface of each circumferential direction groove 20A is the same groove width. Two circumferential direction grooves 20B are also provided at the outer side in the tire fitting direction of the tire equatorial plane CL. A groove width W2 of an aperture surface of each circumferential direction groove 20B is also the same groove width. Here, the groove width W1 of the circumferential direction grooves 20A is formed larger than the groove width W2 of the circumferential direction grooves 20B. Because of this, the total groove width (W1×2) of the circumferential direction grooves 20A that are provided at the inner side in the tire fitting direction of the tire equatorial plane CL is greater than the total groove width (W2×2) of the circumferential direction grooves 20B that are provided at the outer side in the tire fitting direction of the tire equatorial plane CL.

Note that provided that the total groove width of the circumferential direction grooves 20A is formed greater than the total groove width of the circumferential direction grooves 20B, then there are no particular restrictions on the number, the groove width, and the locations of the circumferential direction grooves 20A and the circumferential direction grooves 20B. For example, it is also possible to provide three or more of the circumferential direction grooves 20B, or, conversely, to provide three or more of the circumferential direction grooves 20A. It is also possible for the groove widths of each one of the plurality of circumferential grooves 20A to be mutually different from each other. Furthermore, in the present embodiment, a comparison is made between the groove widths of the aperture surfaces of the circumferential direction grooves 20A and the circumferential grooves 20B, however, the present invention is not limited to this and it is also possible to compare the groove widths of the groove bottom surfaces.

Moreover, a distance L1 extending in the tire width direction from a tread end 20C on the outer side in the tire fitting direction to the closest circumferential direction groove 20B is formed longer than a distance L2 extending in the tire width direction from a tread end 20D on the inner side in the tire fitting direction to the closest circumferential direction groove 20A. Namely, the circumferential direction grooves 20A and the circumferential direction grooves 20B are formed closer to the inner side of the tire fitting direction. Note that the present invention is not limited to this, and it is also possible to make the distance L1 and the distance L2 the same length.

The tire side portion 22 is provided between the bead portion 12 and the tread portion 20. The tire side portion 22 extends in the tire radial direction and links together the bead portion 12 and the tread portion 20. The tire side portion 22 is formed such that it is able to bear the load acting on the tire 10 during run-flat traveling.

The side reinforcement rubber 24 that reinforces the tire side portion 22 is provided at the inner side in the tire width direction of the carcass 14 at the tire side portion 22. The side reinforcement rubber 24 is reinforcement rubber that enables the tire to continue to run for a predetermined distance while supporting the weight of the vehicle and the vehicle occupants when the tire 10 is punctured and the internal pressure thereof has been reduced. Note that in the present embodiment, as an example, side reinforcement rubber having rubber as it principal constituent is employed, however, the present invention is not limited to this. For example, it is also possible to employ thermoplastic resin or the like as the principal constituent for the side reinforcement rubber.

Moreover, in the present embodiment, the side reinforcement rubber 24 is formed by a single rubber component, however, the present invention is not limited to this. For example, it is also possible to form the side reinforcement rubber 24 from a plurality of rubber components. Furthermore, as long as a rubber component is the principal constituent of the side reinforcement rubber 24, then it is also possible for the side reinforcement rubber 24 to additionally contain materials such as fillers, short fibers, and resins and the like. Moreover, in order to increase the tire durability during run-flat traveling, it is also possible for a rubber component having a JIS hardness of 70˜85 as measured at 20° C. using a Durometer hardness tester to be included in the rubber components forming the side reinforcement rubber 24. It is also possible for a rubber component having a loss coefficient tan δ of 0.10 or less as measured using a viscoelasticity spectrometer (for example, a spectrometer manufactured by Toyo Seiki Seisaku-sho, Ltd.) under conditions of a frequency of 20 Hz, an initial distortion of 10%, a dynamic strain of ±2%, and a temperature of 60° C. to be included.

The side reinforcement rubber 24 extends in the tire radial direction along the internal surface of the carcass 14, and is formed in a crescent moon shape whose thickness tapers off as it moves towards both a bead core 26 side and a tread portion 20 side. Moreover, an end portion 24A on the inner side in the tire radial direction of the side reinforcement rubber 24 extends as far as the inner side in the tire width direction of the bead filler 28. An end portion 24B on the outer side in the tire radial direction of the side reinforcement rubber 24 extends as far as the tread portion 20. Note that the thickness referred to here indicates the length of a straight line running perpendicularly relative to the side reinforcement rubber 24 as far as the carcass 14 when the tire 10 is mounted on a standard rim 30 and the internal pressure has been set to the standard air pressure. Note also that the two side reinforcement rubbers 24 may also join together at the tire equatorial plane.

An inner liner (not shown) is provided at an inner surface of the side reinforcement rubber 24 extending from one bead portion 12 to the other bead portion 12. In the present embodiment, as an example, an inner liner whose principal constituent is butyl rubber is provided, however, the present invention is not limited to this. For example, the principal constituent of the inner liner may also be another rubber component or resin or the like. Note that, in the present embodiment, a single layer of the side reinforcement rubber 24 is interposed between the inner liner and the carcass 14, however, the present invention is not limited to this. For example, it is also possible to employ a structure in which another carcass is interposed between the inner liner and the carcass 14 so as to divide the side reinforcement rubber 24.

Moreover, in the present embodiment, because a tire 10 having a high tire cross-sectional height SH is used as a subject, no rim guard (i.e., rim protection) is provided, however, the present invention is not limited to this. For example, it is also possible for a rim guard to be provided.

(Operation and Effects)

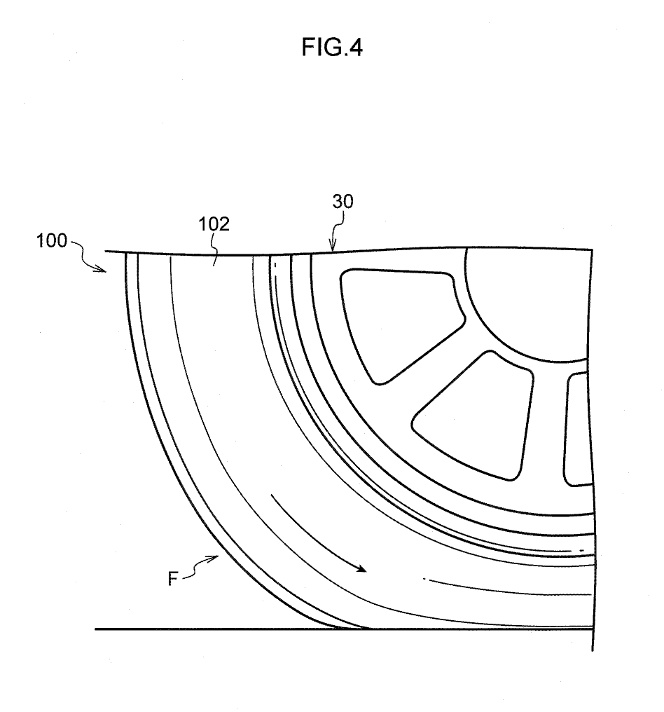

Next, an operation of the tire 10 of the present embodiment will be described by means of an explanation of the buckling phenomenon that occurs in a tire side portion on an inner side of a vehicle turn. In the following description, a tire 100 shown in FIG. 4 is a comparative example that is not provided with the reinforcement cord layer 18 of the present embodiment, and is mounted on a standard rim 30.

As is shown in FIG. 4, during run-flat traveling the portion of the tire 100 that is in contact with the ground is in a considerably flexed state. In this state, if a slip angle is input as a result of cornering, the ground contact portion of the tire 100 is squashed further so that the deflection in the tire 100 increases. As a result, a belt diameter at a tire leading side portion F increases. Because this deflection is transmitted to the front side in the direction of travel of the tire 100, buckling occurs. As a result, the tensile force on an outer side in the tire radial direction acting on the bead portion increases, so that, in combination with the buckling phenomenon in which the tire side portion 102 that is situated on the inner side of the vehicle turn bends towards the inner side of the tire 100, a rim separation phenomenon in which the bead portion comes away from the standard rim 30 also occurs.

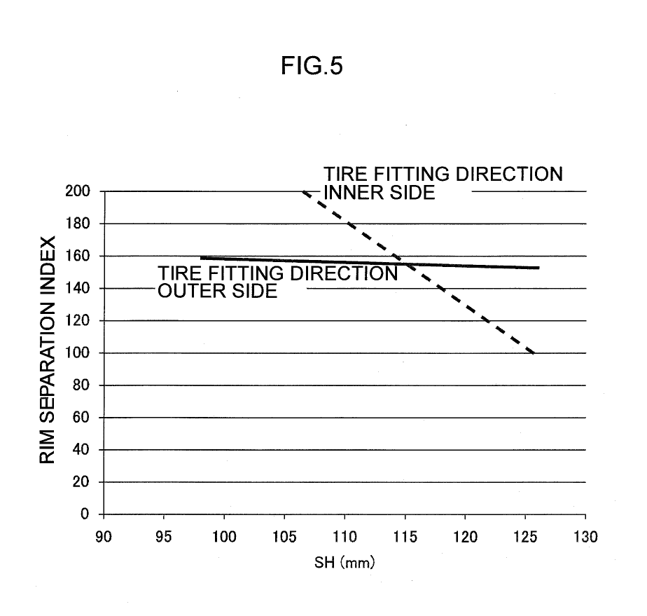

It has been verified that the higher the cross-sectional height of a run-flat tire, the more likely it is that a buckling phenomenon will occur. The graph shown in FIG. 5 shows a rim separation index relative to the tire cross-sectional height that was examined using a run-flat tire in which the tire width was 215 mm, and the tire cross-sectional height SH was altered. According to this graph, in a run-flat tire in which the tire cross-sectional height SH is 115 mm or more, the rim separation index on the inner side in the tire fitting direction is small so that it is easy for rim separation to occur. Namely, it can be verified that it is easy for a buckling phenomenon to occur.

Moreover, a buckling phenomenon is liable to occur when the punctured tire is on the outer side of the turn than when it is on the inner side of the turn. In other words, because one of the factors that causes a buckling phenomenon is the fact that the perpendicular load on the tire is increased by the centrifugal force during a turn, the buckling phenomenon is liable to occur in a run-flat tire that is on the outer side of the turn where the perpendicular load increases during the turn. Moreover, until this point, it has been verified that the buckling phenomenon has occurred exclusively on the inner side in the tire fitting direction of a run-flat tire that was on the outer side of the turn. Note that the term ‘outer side of the turn’ refers to the outer side of a turning circle described by the vehicle center of gravity during a turn (i.e., the vehicle outer side). The term ‘inner side in the tire fitting direction’ refers to the inner side (i.e., the vehicle inner side) in the tire width direction when the tire has been fitted onto a vehicle.

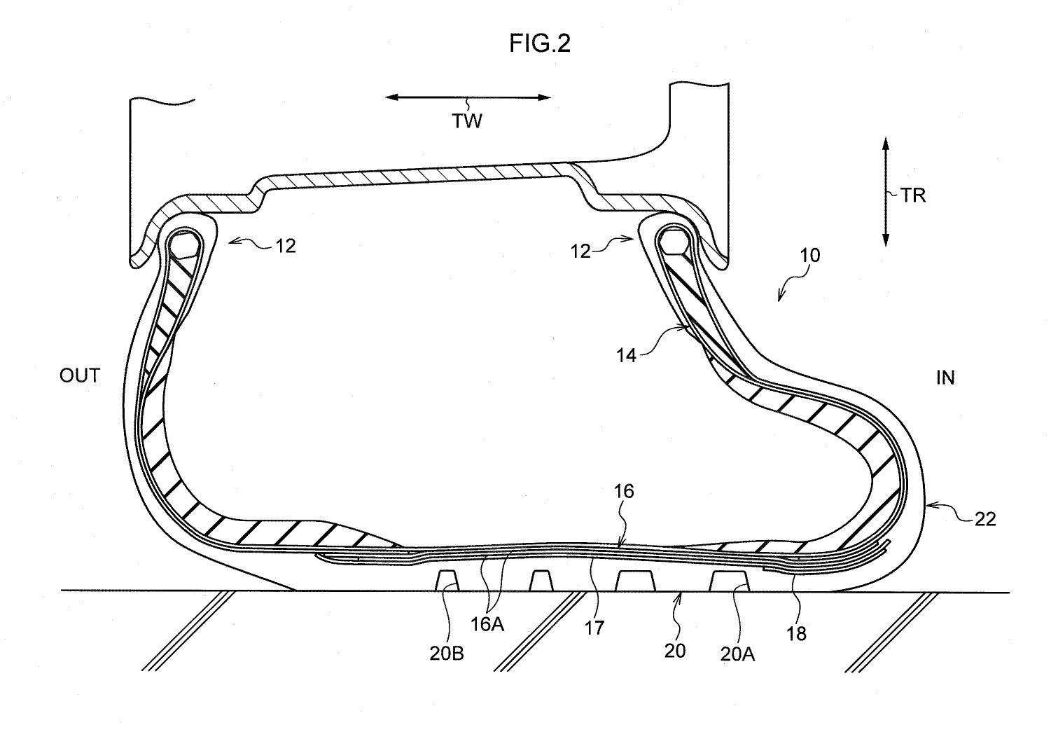

In the tire 10 according to the present embodiment, as is shown in FIG. 1, because the reinforcement cord layer 18 is provided at the inner side in the tire fitting direction of the tire equatorial plane CL, the tensile rigidity is increased and it becomes difficult for the shoulder portion to bend. As a consequence, even if a slip angle is input into the tire 10 during run-flat traveling, as is shown in FIG. 2, any bending of the tire side portion 22 towards the inner side of the tire 10 is largely suppressed, and it is possible to effectively suppress any occurrence of a buckling phenomenon. Namely, it is possible to suppress rim separation.

Moreover, the reinforcement cord layer 18 is only provided at the inner side in the tire fitting direction, and the reinforcement cord layer 18 is not provided at the outer side in the tire fitting direction where it is difficult for a buckling phenomenon to occur. Because of this, it is possible to suppress any increase in the weight of the tire 10. In particular, compared with when the reinforcement cord layer 18 is provided extending over the tire equatorial plane CL, the weight of the reinforcement cord layer 18 can be reduced to less than half.

Furthermore, in the present embodiment, by making the total groove width W1 of the circumferential direction grooves 20A that are provided at the inner side in the tire fitting direction greater than the total groove width W2 of the circumferential direction grooves 20B that are provided at the outer side in the tire fitting direction, the weight balance can be maintained. Namely, because the reinforcement cord layer 18 is only provided at the inner side in the tire fitting direction, the weight of the inner side in the tire fitting direction is increased by the amount of the weight of the reinforcement cord layer 18. On the other hand, by increasing the total groove width W1 of the circumferential direction grooves 20A, the volume of the tread portion 20 on the inner side in the tire fitting direction is decreased, so that the weight increase is canceled out. By employing this structure, the weight balance between the outer side and the inner side in the fitting direction of the tire 10 can be maintained.

Moreover, in a vehicle that is provided with a negative camber, the ground contact pressure on the inner side in the tire fitting direction is increased. Because of this, in order to guarantee the wet performance (i.e., the drainage performance), it is preferable that the groove width W1 of the circumferential direction grooves 20A on the inner side in the tire fitting direction be made larger. If the groove width W1 is increased, then the bend rigidity of the shoulder portion on the inner side in the tire fitting direction is reduced and rim separation becomes a problem. By using the reinforcement cord layer 18 to supplement this reduction in rigidity, it is possible to suppress the occurrence of a buckling phenomenon and achieve both a superior wet performance and a superior dry performance.

### Second Embodiment

Next, a run-flat tire 50 (hereinafter, referred to as a ‘tire 50’) according to a second embodiment of the present invention will be described. Note that component elements that are same as in the above-described first embodiment are given the same symbols and any description thereof is omitted.

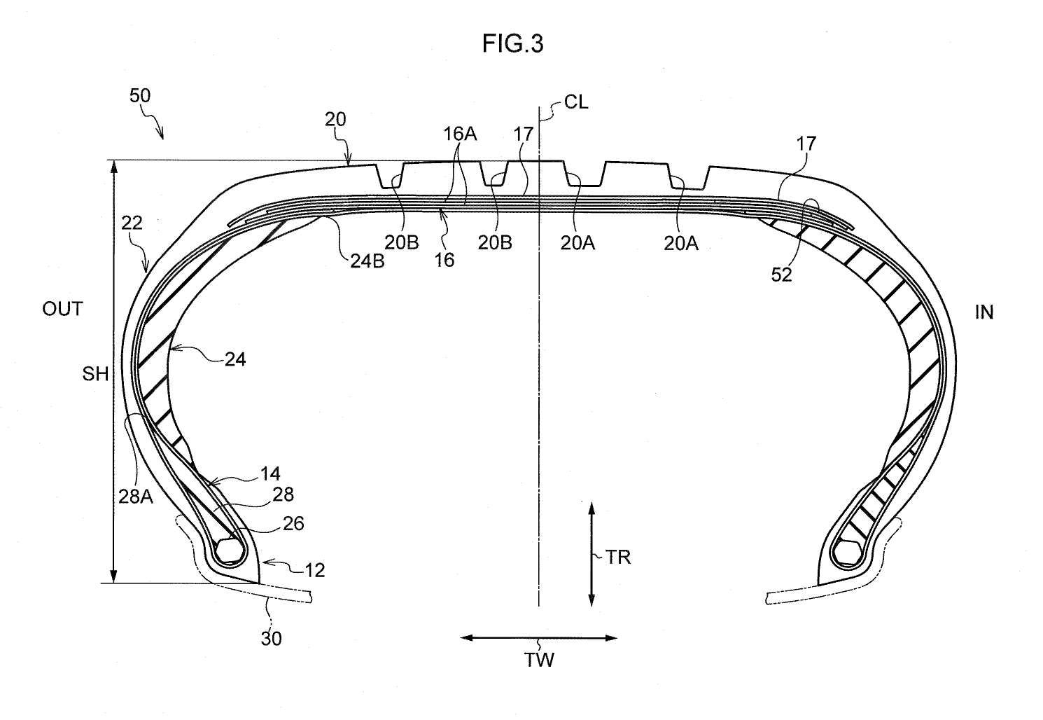

As is shown in FIG. 3, the run-flat tire 50 according to the present embodiment is the same as in the first embodiment except for the location of a reinforcement cord layer 52. Namely, the carcass 14 is provided extending between the pair of bead portions 12. In addition, the inclined belt layer 16 is provided at the outer side in the tire radial direction of the carcass 14. Furthermore, the cap layer 17 is provided as a belt reinforcement layer on the outer side in the tire radial direction of the inclined belt layer 16 so as to cover the inclined belt layer 16.

Here, the reinforcement cord layer 52 of the present embodiment is provided between the inclined belt layer 16 and the cap layer 17, and on the inner side in the tire fitting direction of the tire equatorial plane CL. The reinforcement cord layer 52 is formed by diagonally positioning plural cords at an angle of inclination of between 60° and 90° relative to the tire circumferential direction. In the present embodiment, as an example, the cords are diagonally positioned at an angle of inclination of 90°. Organic fiber cords and metal cords are used for the cords that form the reinforcement cord layer 52. In the present embodiment, as an example, PET is used.

According to the tire 50 of the present embodiment, the same effects as in the first embodiment are achieved. Namely, it is possible to effectively suppress any occurrence of a buckling phenomenon in the tire side portion 22 during run-flat traveling, at the same time as any increase in the weight of the tire 50 is also suppressed.

A first embodiment and a second embodiment have been described above, however, it should be understood that the present invention is not limited to these embodiments and may be achieved in a variety of ways insofar as they do not depart from the scope of the present invention. For example, in FIG. 3, it is also possible to employ a structure in which a separate reinforcement cord layer is provided at the outer side in the tire radial direction of the cap layer 17 on the inner side in the tire fitting direction, so that the cap layer 17 is sandwiched from above and below. It is also possible to provide plural cap layers and to interpose the reinforcement cord layer between cap layers.

Priority is claimed on Japanese Patent Application No. 2014-083086, filed Apr. 14, 2014, the disclosure of which is incorporated herein by reference.

All references, patent applications and technical specifications cited in the present specification are incorporated by reference into the present specification to the same extent as if the individual references, patent applications and technical specifications were specifically and individually recited as being incorporated by reference.

1. A run-flat tire, comprising:
a carcass that spans a region between a pair of bead portions;
a side reinforcement layer that is provided at a tire side portion that connects the bead portions and a tread portion;
an inclined belt layer that is provided at an outer side of the carcass in a tire radial direction so as to span a tire equatorial plane, and that is formed by cords that are inclined relative to a tire circumferential direction; and
a reinforcement cord layer that is provided at an outer side of the inclined belt layer in the tire radial direction, and only at a half portion of the tire that is located at an inner side in a tire fitting direction of the tire equatorial plane, and that is formed by cords that are inclined relative to the tire circumferential direction.

2. The run-flat tire according to claim 1, further comprising a belt reinforcement layer that is formed from cords that extend in the tire circumferential direction, and that is provided at an outer side of the inclined belt layer in the tire radial direction, wherein the reinforcement cord layer is provided between the inclined belt layer and the belt reinforcement layer.

3. The run-flat tire according to claim 1, further comprising a belt reinforcement layer that is formed from cords that extend in the tire circumferential direction, and that is provided at an outer side of the inclined belt layer in the tire radial direction, wherein the reinforcement cord layer is provided at an outer side of the belt reinforcement layer in the tire radial direction.

4. The run-flat tire according to claim 1, wherein:
the tread portion is provided with a plurality of circumferential direction grooves that extend in the tire circumferential direction; and
of the plurality of circumferential direction grooves, a total groove width of circumferential direction grooves that are provided at the inner side in the tire fitting direction of the tire equatorial plane is greater than a total groove width of circumferential direction grooves that are provided at an outer side in the tire fitting direction of the tire equatorial plane.

5. The run-flat tire according to claim 1, wherein:
the tread portion is provided with a plurality of circumferential direction grooves that extend in the tire circumferential direction; and
a distance L1 extending in a tire width direction from a tread end on an outer side in the tire fitting direction to a closest circumferential direction groove is formed longer than a distance L2 extending in the tire width direction from a tread end on the inner side in the tire fitting direction to a closest circumferential direction groove.
